(19) United States
(12) Patent Application Publication
(10) Pub. No.: US 2025/0119173 A1
(43) Pub. Date: Apr. 10, 2025

(54) METHOD FOR DYNAMICALLY ALLOCATING RADIO FREQUENCY EXPOSURE AMONG MULTIPLE RADIO FREQUENCY GROUPS AND ASSOCIATED CONTROL CIRCUIT

(71) Applicant: MEDIATEK INC., Hsinchu City (TW)

(72) Inventors: Fu-Tse Kao, Hsinchu City (TW); Yi-Hsuan Lin, Hsinchu City (TW); Tsung-Po Yu, Hsinchu City (TW)

(73) Assignee: MEDIATEK INC., Hsinchu City (TW)

(21) Appl. No.: 18/882,706

(22) Filed: Sep. 11, 2024

Related U.S. Application Data
(60) Provisional application No. 63/587,757, filed on Oct. 4, 2023.

(51) Int. Cl. H04B 1/3827; H04W 52/24; H04W 52/36

(52) U.S. Cl. CPC H04B 1/3838; H04W 52/241; H04W 52/367

(57) ABSTRACT

A method for dynamically allocating radio frequency (RF) exposure across multiple RF groups including a first RF group and a second RF group includes: estimating RF exposure of the first RF group according to at least one message of the first RF group, in order to generate estimated RF exposure; calculating RF exposure of the second RF group according to at least one message of the second RF group, the estimated RF exposure, and one or more equations, in order to generate calculated RF exposure, wherein the one or more equations are associated with a predetermined regulation; and determining a TX power limit corresponding to the first RF group and a TX power limit corresponding to the second RF group according to the estimated RF exposure and the calculated RF exposure, respectively.

### CROSS REFERENCE TO RELATED APPLICATIONS

This application claims the benefit of U.S. Provisional Application No. 63/587,757, filed on Oct. 4, 2023. The content of the application is incorporated herein by reference.

### BACKGROUND

The present invention is related to radio frequency (RF) technology, and more particularly, to a method for dynamically allocating RF exposure across multiple RF groups and an associated control circuit.

Nowadays, the RF technology has often appeared in a user equipment (UE; such as a mobile phone). However, excessive RF exposure may cause harm to human body. As a result, officials of different countries (e.g. federal communications commission (FCC) of USA, innovation, science, and economic development (ISED) of Canada, and conformite europeenne (CE) of Europe) regulate a time-averaged RF exposure limit to limit a time-averaged RF exposure of a radio module in the UE. For example, in response to a frequency band of the radio module being smaller than 6 GHZ, the time-averaged RF exposure will be quantified with a time-averaged specific absorption rate (SAR), and in response to the frequency band of the radio module being not smaller than 6 GHz, the time-averaged RF exposure will be quantified with a time-averaged power density (PD). In addition, since the time-averaged RF exposure will be proportional to a transmitting (TX) power of the radio module, the time-averaged RF exposure can meet the time-averaged RF exposure limit by controlling the TX power.

For simultaneous multi-radio access technology (multi-RAT) transmission (e.g. 2G, 3G, 4G, 5G, non-terrestrial networks (NTN), wireless fidelity (Wi-Fi), and Bluetooth (BT)), the officials regulate that a total exposure ratio (TER) must be less than or equal to 1 (i.e. TER≤1). For example, the TER may be calculated by combining normalized values of measurement results regarding SAR (e.g., values obtained by dividing each measurement result by a corresponding regulation limit). In addition, under a situation that some conditions are met, the radio modules can be grouped according to a predetermined regulation in order to obtain multiple RF groups, wherein SAR calculation for each RF group is independent. For a conventional method, a fixed SAR value will be set for each RF group, which reduces performance and flexibility. As a result, a novel method for dynamically allocating RF exposure across multiple RF groups and an associated control circuit are urgently needed.

### SUMMARY

It is therefore one of the objectives of the present invention to provide a method for dynamically allocating RF exposure across multiple RF groups and an associated control circuit, in order to address the above-mentioned issues.

According to an embodiment of the present invention, a method for dynamically allocating RF exposure across multiple RF groups is provided, wherein the multiple RF groups comprise a first RF group and a second RF group. The method comprises: estimating RF exposure of the first RF group according to at least one message of the first RF group, in order to generate estimated RF exposure; calculating RF exposure of the second RF group according to at least one message of the second RF group, the estimated RF exposure, and one or more equations, in order to generate calculated RF exposure, wherein the one or more equations are associated with a predetermined regulation; and determining a TX power limit corresponding to the first RF group and a TX power limit corresponding to the second RF group according to the estimated RF exposure and the calculated RF exposure, respectively.

According to an embodiment of the present invention, a control circuit is provided, wherein multiple RF groups comprise a first RF group and a second RF group, and the control circuit is arranged to: interact with the first RF group in order to receive estimated RF exposure of the first RF group, wherein the estimated RF exposure is associated with at least one message of the first RF group; calculate RF exposure of the second RF group according to at least one message of the second RF group, the estimated RF exposure, and one or more equations, in order to generate calculated RF exposure, wherein the one or more equations are associated with a predetermined regulation; and determine a TX power limit corresponding to the first RF group and a TX power limit corresponding to the second RF group according to the estimated RF exposure and the calculated RF exposure, respectively.

One of the benefits of the present invention is that, by the method of the present invention and an associated control circuit, RF exposure can be dynamically allocated across multiple RF groups, and the allocated results still comply with regulations of the RF exposure limit. In this way, the performance of each RF group can be optimized and the design flexibility can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a diagram illustrating an RF exposure dynamic allocation scheme for two RF groups according to an embodiment of the present invention.

FIG. 3 is a flow chart of a method for dynamically allocating RF exposure across multiple RF groups according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

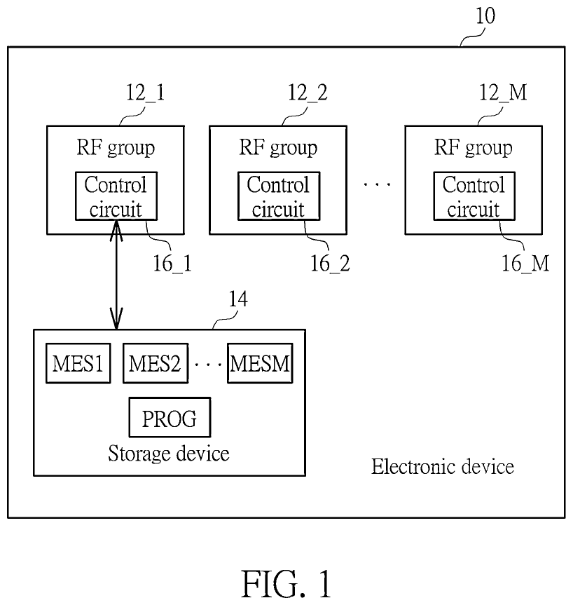

FIG. 1 is a diagram illustrating an electronic device 10 according to an embodiment of the present invention. By way of example, but not limitation, the electronic device 10 may be a portable device such as a smartphone, a wearable device, or a tablet. As shown in FIG. 1, the electronic device 10 may include multiple radio frequency (RF) groups 12_1-12_M and a storage device 14, wherein each of the RF groups 12_1-12_M may include one or more radio modules and a control circuit, and “M” is a positive integer greater than one (i.e., M≥2). For example, the RF group 12_1 may include a control circuit 16_1, the RF group 12_2 may include a control circuit 16_2, and the RF group 12_M may include a control circuit 16_M. Each radio module may include communication circuits corresponding to 2G, 3G, 4G, 5G, wireless fidelity (Wi-Fi), Bluetooth (BT), and/or non-terrestrial networks (NTN), and the RF groups 12_1-12_M may support multi-radio access technology (multi-RAT) transmission with aid of the communication circuits, but the present invention is not limited thereto.

The storage device 14 is a non-transitory machine-readable medium, and is arranged to store computer program code PROG. The electronic device 10 may be regarded as a computer system using a computer program product that includes a computer-readable medium containing the computer program code PROG. The control circuit included in each RF group is equipped with software execution capability. When loaded and executed by the control circuit, the computer program code PROG instructs the control circuit to dynamically allocate RF exposure across the RF groups 12_1-12_M.

Specifically, the control circuit may estimate RF exposure of a corresponding RF group for interacting with other RF groups, wherein the estimated RF exposure of the corresponding RF group is associated with at least one corresponding message included in the storage device 14. The storage device 14 may store at least one message MES1, at least one message MES2, . . . , and at least one message MESM that are respectively associated with the RF groups 12_1, 12_2, . . . , and 12_M, and each message may include some information of each radio module included in an associated RF group. By way of example, but not limitation, the information of the radio module may include a previous transmitting (TX) power ratio, a TX power ratio margin, one or more TX performance indices, one or more receiving (RX) performance indices, one or more weighting information, or one or more configurations. For example, the associated RF group may include circuits arranged to receive the one or more weighting information from a user or different scenarios for allocating TX power ratios of the radio modules therein, and store the one or more weighting information in the storage device 14.

The one or more TX performance indices may include at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

The one or more RX performance indices may include at least one of a duty cycle of RX, the MCS, a received signal strength indication (RSSI), a reference signal receiving power (RSRP), a signal to noise ratio (SNR), a signal-to-interference-plus-noise ratio (SINR), and an RX packet error rate (RX PER).

The one or more configurations may be related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and an subscriber identity module (SIM).

Take the control circuit 16_1 included in the RF group 12_1 as an example. The control circuit 16_1 may estimate RF exposure of the RF group 12_1 according to the at least one message MES1 included in the storage device 14, in order to generate estimated RF exposure of the RF group 12_1. In addition, the control circuit 16_1 may also interact with other RF groups in order to receive respective estimated RF exposure of the RF groups, and calculate RF exposure of the RF group 12_1 according to the respective estimated RF exposure of the RF groups, the at least one message MES1, and one or more equations, in order to generate calculated RF exposure of the RF group 12_1, wherein the one or more equations are associated with a predetermined regulation. In this embodiment, the predetermined regulation is a specific absorption rate to peak location separation ratio (SPLSR) regulation. Specifically, an SPLSR equation is expressed as follows:

$${( \frac{S A {R}_{1} + S A {R}_{2}}{R} )}^{1.5}$$

wherein “SAR₁” represents a specific absorption rate (SAR) value of a radio module, “SAR₂” represents the SAR value of another radio module, and “R” is a separation distance between a peak SAR location of the radio module and a peak SAR location of the another radio module, and may be a fixed value.

For 1g SAR, the SPLSR equation is regulated to be less than or equal to 0.04

$$( i . e . {( \frac{S A {R}_{1} + S A {R}_{2}}{R} )}^{1.5} \leq 0.04 ) .$$

For 10g SAR, the SPLSR equation is regulated to be less than or equal to 0.1

$$( i . e . {( \frac{S A {R}_{1} + S A {R}_{2}}{R} )}^{1.5} \leq 0.1 ) .$$

Under a condition that any radio module in a radio group and any radio module in another radio group satisfy the SPLSR regulations, a total exposure ratio (TER) calculation of the radio group and a TER calculation of the another radio group can be independent. That is, under a condition that the radio groups 12_1 and 12_2 comply with SPLSR regulations, a sum of the TER of any radio module(s) in the radio group 12_1 and the TER of any radio module(s) in the radio group 12_2 can be greater than 1.

For better comprehension, assume that the number of radio groups 12_1-12_M is two (i.e., M=2; e.g., the RF groups 12_1 and 12_2), and each of the RF groups 12_1 and 12_2 includes only a single radio module. The control circuit 16_2 included in the RF group 12_2 may interact with the RF group 12_1 in order to receive the estimated RF exposure of the RF group 12_1 (which is regarded as “SAR₁” in the SPLSR equation), and calculate RF exposure of the RF group 12_2 according to the at least one message MES2, the estimated RF exposure of the RF group 12_1, and the above-mentioned SPLSR equation. For example, the calculated RF exposure of the RF group 12_2 (which is regarded as “SAR₂” in the SPLSR equation) can be dynamically allocated by the following equation for 1g SAR:

$$S A {R}_{2} < \sqrt[1.5]{0.04 R} - S A {R}_{1}$$

wherein since “SAR₁” and “R” are known, “SAR₂” can be dynamically allocated to be smaller than a predetermined value

$$( i . e . , \sqrt[1.5]{0.04 R} - SA {R}_{1} )$$

for complying with the SPLSR regulations.

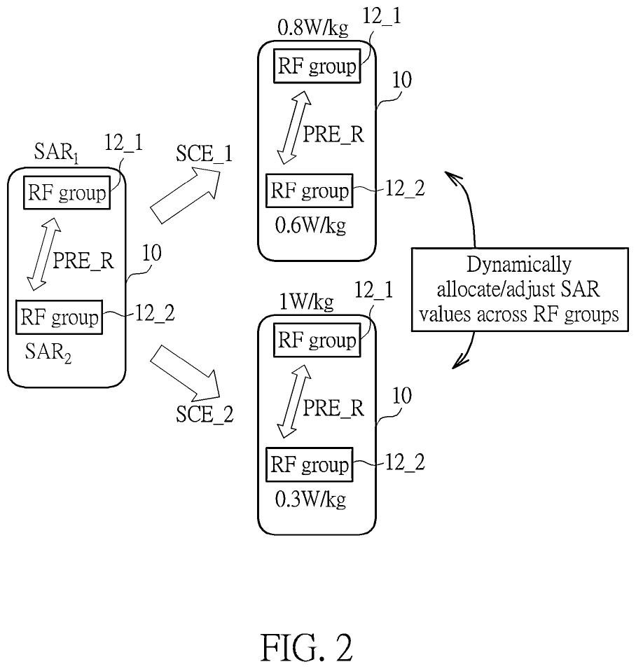

FIG. 2 is a diagram illustrating an RF exposure dynamic allocation scheme for two RF groups (e.g., RF groups 12_1 and 12_2) according to an embodiment of the present invention. As shown in FIG. 2, assume that the electronic device 10 includes two RF groups 12_1 and 12_2, each RF group includes only a single radio module, and a separation distance between peak SAR locations of respective radio modules in the RF groups 12_1 and 12_2 is a predetermined distance PRE R (e.g., 45 millimeters (mm)). The control circuit 16_1 included in the RF group 12_1 and the control circuit 16_2 included in the RF group 12_2 may dynamically allocate RF exposure across the RF groups 12_1 and 12_2 according to different scenarios (e.g., scenarios SCE_1 and SCE_2). Compared with the RF group 12_1 in the scenario SCE_2, the RF group 12_1 in the scenario SCE_1 requires less RF exposure (or less SAR value).

In the scenario SCE_1, the control circuit 16_1 estimates the RF exposure of the RF group 12_1 according to the at least one message MES1 associated with the RF group 12_1, in order to generate estimated RF exposure of the RF group 12_1, wherein the estimated RF exposure of the RF group 12_1 may be quantified with the SAR to obtain a SAR value of 0.8 W/kg. Based on the message MES2 associated with the RF group 12_2, the estimated RF exposure of the RF group 12_1, and the above-mentioned equation for 1g SAR

$$( i . e . , {SAR}_{2} < \sqrt[1.5]{0.04 * 45} - 0.8 ) ,$$

the control circuit 16_2 can dynamically allocate the calculated RF exposure of the RF group 12_2 as a SAR value of 0.6 W/kg that is smaller than the predetermined value

$$( i . e . , \sqrt[1.5]{0.04 * 45} - 0.8 ) ,$$

wherein the SAR values respectively corresponding to the RF groups 12_1 and 12_2 still conform to the SPLSR equation for 1g SAR

$$( i . e . , {( \frac{0.8 + 0.6}{45} )}^{1.5} \approx 0.0 \; 37 < 0.04 ) .$$

In the scenario SCE_2, the control circuit 16_1 estimates the RF exposure of the RF group 12_1 according to the at least one message MES1 associated with the RF group 12_1, in order to generate estimated RF exposure of the RF group 12_1, wherein the estimated RF exposure of the RF group 12_1 may be quantified with the SAR to obtain a SAR value of 1 W/kg. Based on the message MES2 associated with the RF group 12_2, the estimated RF exposure of the RF group 12_1, and the above-mentioned equation for 1g SAR

$$( i . e . , {SAR}_{2} < \sqrt[1.5]{0.04 * 45} - 1 ) ,$$

the control circuit 16_2 can dynamically allocate the calculated RF exposure of the RF group 12_2 as a SAR value of 0.3 that is smaller than the predetermined value

$$( i . e . , {SAR}_{2} < \sqrt[1.5]{0.04 * 45} - 1 ) ,$$

wherein the SAR values respectively corresponding to the RF groups 12_1 and 12_2 still conform to the SPLSR equation for 1g SAR

$$( i . e . , {( \frac{1 + 0.3}{45} )}^{1.5} \approx 0.0 \; 33 < 0.04 ) .$$

The RF exposure dynamic allocation in this embodiment, however, is for illustrative purposes only, and is not meant to be a limitation of the present invention. In some embodiments, the RF exposure dynamic allocation may be performed upon more than two RF groups. Take three RF groups (e.g., RF groups 12_1-12_3, where M=3) as an example. The estimation operation may be performed upon the RF group 12_1 to generate estimated RF exposure of the RF group 12_1, and respective RF exposure of the RF groups 12_2 and 12_3 may be calculated according to the at least one message of the corresponding RF group, the estimated RF exposure of the RF group 12_1, and the above-mentioned SPLSR equation. Alternatively, the estimation operation may be performed upon two RF groups among the RF groups 12_1-12_3 (e.g., the RF groups 12_1 and 12_2) to generate multiple estimated RF exposure, and RF exposure of the remaining RF group (e.g., the RF group 12_3) may be calculated according to the least one message MES3 of the RF group 12_3, the multiple estimated RF exposure, and the above-mentioned SPLSR equation. These alternative designs all fall within the scope of the present invention.

Afterwards, the radio group 12_1 (more particularly, the control circuit 16_1 included in the radio group 12_1) may be arranged to receive a time-averaged RF exposure limit regulated by officials (for brevity, hereinafter denoted by “RF exposure limit”), wherein the RF exposure limit corresponds to the radio group 12_1. Since the RF exposure limit is proportional to a TX power of the radio group 12_1, the control circuit 12_1 may be further arranged to map the RF exposure limit to a TX power limit TPL1 of the radio group 12_1. Specifically, the RF exposure limit may be the TER, wherein the TER may include a normalized average SAR limit, and the TER is required to be less than or equal to 1 (i.e. TER≤1). The control circuit 12_1 may utilize a test or a simulation to find a normalized average TX power limit mapped to the normalized average SAR limit, wherein the TX power limit TPL1 includes the normalized average TX power limit. However, this is for illustration only, and the present invention is not limited thereto. In some embodiments, the user may directly utilize the test or the simulation to find the TX power limit TPL1. That is, the RF exposure limit may also be mapped to the TX power limit TPL1 of the radio group 12_1 directly by the user.

After RF exposure (e.g., SAR values, such as the estimated SAR value and the calculated SAR value) is dynamically allocated between the radio groups 12_1 and 12_2, the control circuit 16_1 may be further arranged to adjust the TX power limit TPL1 according to the estimated SAR value, in order to determine an adjusted TX power limit ATPL1 of the radio group 12_1.

After determining the adjusted TX power limit ATPL1, the control circuit 16_1 may control an instantaneous power of the radio group 12_1 to make an average power of the radio group 12_1 lower than or equal to the adjusted TX power limit ATPL1, in order to comply with regulations of the RF exposure limit. Similarly, the control circuit 16_1 may determine an adjusted TX power limit ATPL2 of the radio group 12_2 according to the calculated SAR value, and control an instantaneous power of the radio group 12_2 to make an average power of the radio group 12_2 lower than or equal to the adjusted TX power limit ATPL2, in order to comply with regulations of the RF exposure limit. Since related operations of the TX power limit are well known to those with ordinary knowledge in the art, and the focus of the present invention is on the dynamic allocation of RF exposure across multiple RF groups, the details of the related operations of the TX power limit will be omitted for brevity.

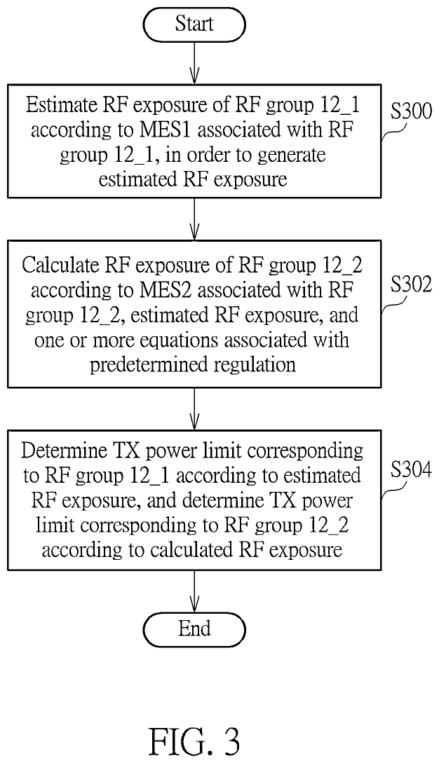

FIG. 3 is a flow chart of a method for dynamically allocating RF exposure across multiple RF groups according to an embodiment of the present invention. Provided that the result is substantially the same, the steps are not required to be executed in the exact order shown in FIG. 3. For example, assume that the number of radio groups 12_1-12_M included in the electronic device 10 is two (e.g., the RF groups 12_1 and 12_2), and the method shown in FIG. 3 may be employed by the control circuits 16_1 and 16_2 shown in FIG. 1.

In Step S300, RF exposure of the RF group 12_1 is estimated according to the at least one message MES1 stored in the storage device 14, in order to generate estimated RF exposure, wherein the at least one message MES1 is associated with the RF group 12_1.

In Step S302, RF exposure of the RF group 12_2 is calculated according to the at least one message MES2 associated with the RF group 12_2, the estimated RF exposure, and one or more equations associated with a predetermined regulation (e.g., the above-mentioned SPLSR equation).

In Step S304, a TX power limit corresponding to the RF group 12_1 is determined according to the estimated RF exposure, and a TX power limit corresponding to the RF group 12_2 is determined according to the calculated RF exposure.

Since a person skilled in the pertinent art can readily understand details of the steps after reading above paragraphs directed to the control circuits 16_1 and 16_2 shown in FIG. 1, further descriptions are omitted here for brevity.

In summary, by the method of the present invention and an associated control circuit, RF exposure can be dynamically allocated across multiple RF groups, and the allocated results still comply with regulations of the RF exposure limit. In this way, the performance of each RF group can be optimized and the design flexibility can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for dynamically allocating radio frequency (RF) exposure across multiple RF groups, wherein the multiple RF groups comprise a first RF group and a second RF group, and the method comprises:
estimating RF exposure of the first RF group according to at least one message of the first RF group, in order to generate estimated RF exposure;
calculating RF exposure of the second RF group according to at least one message of the second RF group, the estimated RF exposure, and one or more equations, in order to generate calculated RF exposure, wherein the one or more equations are associated with a predetermined regulation; and
determining a transmitting (TX) power limit corresponding to the first RF group and a TX power limit corresponding to the second RF group according to the estimated RF exposure and the calculated RF exposure, respectively.

2. The method of claim 1, wherein the predetermined regulation is a specific absorption rate to peak location separation ratio (SPLSR) regulation.

3. The method of claim 1, wherein each of the at least one message of the first RF group and the at least one message of the second RF group comprises a previous TX power ratio, a TX power ratio margin, one or more TX performance indices, one or more receiving (RX) performance indices, one or more weighting information, or one or more configurations.

4. The method of claim 3, wherein each of the at least one message of the first RF group and the at least one message of the second RF group comprises the one or more TX performance indices, comprising at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

5. The method of claim 3, wherein each of the at least one message of the first RF group and the at least one message of the second RF group comprises the one or more RX performance indices, comprising at least one of a duty cycle of RX, a modulation and coding scheme (MCS), a received signal strength indication (RSSI), a reference signal RX power (RSRP), a signal to noise ratio (SNR), a signal to interference plus noise ratio (SINR), and an RX packet error rate (RX PER).

6. The method of claim 3, wherein each of the at least one message of the first RF group and the at least one message of the second RF group comprises the one or more configurations related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and a subscriber identity module (SIM).

7. A control circuit, wherein multiple radio frequency (RF) groups comprise a first RF group and a second RF group, and the control circuit is arranged to:
interact with the first RF group in order to receive estimated RF exposure of the first RF group, wherein the estimated RF exposure is associated with at least one message of the first RF group;
calculate RF exposure of the second RF group according to at least one message of the second RF group, the estimated RF exposure, and one or more equations, in order to generate calculated RF exposure, wherein the one or more equations are associated with a predetermined regulation; and
determine a transmitting (TX) power limit corresponding to the first RF group and a TX power limit corresponding to the second RF group according to the estimated RF exposure and the calculated RF exposure, respectively.

8. The control circuit of claim 7, wherein the predetermined regulation is a specific absorption rate to peak location separation ratio (SPLSR) regulation.

9. The control circuit of claim 7, wherein each of the at least one message of the first RF group and the at least one message of the second RF group comprises a previous TX power ratio, a TX power ratio margin, one or more TX performance indices, one or more receiving (RX) performance indices, one or more weighting information, or one or more configurations.

10. The control circuit of claim 9, wherein each of the at least one message of the first RF group and the at least one message of the second RF group comprises the one or more TX performance indices, comprising at least one of a duty cycle of TX, an error vector magnitude (EVM) of TX, a target power, a throughput, a modulation and coding scheme (MCS), a block error rate (BLER), a resource block (RB), a transmission block size (TBS), and a TX packet error rate (TX PER).

11. The control circuit of claim 9, wherein each of the at least one message of the first RF group and the at least one message of the second RF group comprises the one or more RX performance indices, comprising at least one of a duty cycle of RX, a modulation and coding scheme (MCS), a received signal strength indication (RSSI), a reference signal RX power (RSRP), a signal to noise ratio (SNR), a signal to interference plus noise ratio (SINR), and an RX packet error rate (RX PER).

12. The control circuit of claim 9, wherein each of the at least one message of the first RF group and the at least one message of the second RF group comprises the one or more configurations related to at least one of an antenna, a band, a beam, a technology, a sub-band, one or more exposure condition indices, a simultaneous transmitted state, a mobile country code (MCC), a mobile network code (MNC), a modulation, a bandwidth, a maximum power reduction (MPR), a path, a duty cycle, and a combination of the band and a subscriber identity module (SIM).

13. The control circuit of claim 7, wherein the control circuit is further arranged to estimate RF exposure of the second RF group according to the at least one message of the second RF group, for interacting with the first RF group.
